(19) United States
(12) Patent Application Publication
(10) Pub. No.: US 2026/0251070 A1
(43) Pub. Date: Aug. 27, 2026

(54) TURBOMACHINE ASSEMBLY COMPRISING PLATFORMS HAVING EDGES PROVIDED WITH COMPLEMENTARY PROTRUSIONS AND NOTCHES AND ASSOCIATED TURBOMACHINE

(71) Applicants: SAFRAN AIRCRAFT ENGINES, PARIS (FR); SAFRAN CERAMICS, LE HAILLAN (FR)

(72) Inventors: Fabrice Joël Luc CHEVILLOT, MOISSY-CRAMAYEL (FR); Lucien Henri Jacques QUENNEHEN, MOISSY-CRAMAYEL (FR); Fabrice Marcel Noël GARIN, MOISSY-CRAMAYEL (FR); Romain Claude Gabriel BARDON, MOISSY-CRAMAYEL (FR)

(21) Appl. No.: 18/877,860

(22) PCT Filed: Jun. 12, 2023
(86) PCT No.: PCT/FR2023/050846

§ 371 Date: Dec. 20, 2024

(30) Foreign Application Priority Data
Jun. 22, 2022 (FR) FR2206152

(51) Int. Cl. F01D 5/28; F01D 25/00

(52) U.S. Cl. CPC F01D 5/282; F01D 5/225; F01D 25/005; F05D 2260/36

(57) ABSTRACT

A bladed turbomachine assembly extends about an axis (AX) and includes disc carrying blades (21a-21d), wherein each blade (21a-21d) extends radially from a root by which it is rigidly connected to the disc to a heel including a platform (26a-26d). The assembly includes an alternation of blades (21a, 21c) prestressed towards upstream and blades (21b, 21d) prestressed towards downstream, each blade (21a, 21c) prestressed towards upstream having its heel (24c) tending to shift towards upstream, each blade (21b, 21d) prestressed towards downstream having its heel (24b) tending to shift towards downstream.

The pairs of circumferentially adjacent blades have platforms (26a-26d), contiguous circumferential ends of which (27b-27d, 28a-28c) include protrusions (29a-29c) and notches (31b-31d) fitting together.

Each protrusion (29a-29c) is pressed into a notch (31b-31d) receiving it according to the axial direction (AX) by the prestresses of the blades that carry them.

### TECHNICAL FIELD

The invention relates to the reduction of the vibrations in a bladed turbomachine disc in service.

### PRIOR ART

In such a turbojet 1 shown in FIG. 1, the outside air enters an intake duct 2 to pass through a fan 3 including a series of rotary aerofoils before splitting into a central primary airflow and a bypass airflow surrounding the primary airflow.

The primary airflow is then compressed in a first and a second compression stage 4 and 5 before arriving in a combustion chamber 6, after which it expands while passing through a set of turbines 7 and 8 before being evacuated downstream while generating thrust. As for the bypass airflow, it is propelled directly rearward by the fan in a jet defined by the casing 9 to generate a complementary thrust.

In practice, such an engine includes a rotor rotating about its longitudinal axis AX, and including several discs each carrying at its outer periphery a series of blades or aerofoils, these discs corresponding to the fan, to the compressors and to the turbines.

As shown in FIG. 2, such a blade 11a includes a root 12a by which it is fastened to a disc (not shown), extended by an aerofoil 13a that extends according to a spanwise direction EVa radial with respect to the axis of rotation. This aerofoil 13a ends in a heel 14a including a platform 16a or heel carrying here two portions of fins 17a, 18a intended to ensure sealing functions.

The blades carried by the same disc have the same morphology, so that the blade 11b circumferentially contiguous to the blade 11a in FIG. 2 includes the same components labelled with the same numerical references but completed by the letter b instead of the letter a.

The outer periphery of a bladed disc is thus defined by the platforms of the blades that it carries, which extend contiguously to each other to jointly define a substantially cylindrical peripheral shroud.

During operation, these blades undergo high temperatures and significant centrifugal stresses, which tend to increase their length according to their spanwise direction. In these conditions, the contiguous platforms, which touch each other when the turbomachine is stopped, tend to become spaced apart circumferentially from each other when the turbomachine is in service, this spacing or play being labelled J in FIG. 2.

Given the vibrational excitations present in such a turbomachine, this situation can lead to modes of vibration of the blades by which their platforms tend to bump into each other circumferentially, which is capable of degrading them.

Such modes of vibration can appear on the blades that are rotary that is to say carried by discs, but also appear in blades that are stationary that is to say carried by a fixed element such as a rectifier located for example downstream of a bladed disc of a fan or of a compressor to reduce the gyration of the flow having passed through the rotary blades.

One solution for damping the modes of vibration is to prestress each blade in torsion during their mounting on the disc. In this case, the platforms tend to rotate about their spanwise axes, so that the edges of the platforms of two adjacent blades remain bearing against one another despite the effects of the centrifugal stresses and of the thermal expansion. During operation, the modes of vibration of the blades engender friction at the bearing points of the platforms which allows to damp these modes of vibration by friction.

In this context, the object of the invention is to provide a solution to limit the modes of vibration of bladed discs, in particular for the case of blades made of ceramic matrix composite material having an acceptable prestress lower than that of the blades made of metal alloy.

### DISCLOSURE OF THE INVENTION

For this purpose, the object of the invention is a bladed turbomachine assembly extending circumferentially about an axis of rotation, and comprising blades, wherein each blade extends radially with respect to the axis of rotation up to a heel located at a free radial end of the blade, this heel including a platform, characterised in that:
it includes, circumferentially arranged about the axis of rotation, an alternation of blades prestressed towards upstream and blades prestressed towards downstream, each blade prestressed towards upstream having its heel tending to shift towards upstream, each blade prestressed towards downstream having its heel tending to shift towards downstream;
the pairs of circumferentially adjacent blades have platforms, circumferentially contiguous edges of circumferential ends of which include protrusions and notches fitting together one in another;
each protrusion is in axial contact in a notch receiving it, this contact being maintained by the prestresses of the blades that carry them.

With this arrangement, the blades must be prestressed substantially according to the axial direction, which significantly simplifies the implementation of a solution for damping modes of vibration.

The invention also relates to a bladed assembly thus defined, wherein the protrusions and the notches globally each have the shape of a parallelogram.

The invention also relates to a bladed assembly thus defined, wherein the protrusions and the notches extend according to a direction mainly circumferential with respect to the axis of rotation.

The invention also relates to a bladed assembly thus defined, wherein each edge of a circumferential end of a platform includes several protrusions or several notches.

The invention also relates to a bladed assembly thus defined, wherein each platform includes one circumferential end edge provided with at least one notch, and another circumferentially opposite circumferential end edge that is provided with at least one protrusion.

The invention also relates to a bladed assembly thus defined, wherein the blades are made of ceramic matrix composite material.

The invention also relates to a bladed assembly thus defined, wherein the blades are prestressed by offsetting according to the axis of rotation their roots with respect to the disc that carries them according to a substantially axial direction.

The invention also relates to a bladed assembly thus defined, wherein the blades are prestressed by being curved towards upstream or towards downstream when viewed in a plane containing the axis of rotation.

The invention also relates to a turbomachine comprising an assembly thus defined.

### BRIEF DESCRIPTION OF THE DRAWINGS

FIG. 1 is a longitudinal cross-sectional view of a known turbojet;

FIG. 2 is a perspective view of two circumferentially adjacent blades provided in a rotary disc according to an arrangement known from the prior art;

FIG. 3 is a perspective view of two circumferentially adjacent blades provided in a rotary disc according to the invention;

FIG. 4 is a top view of the platforms of four circumferentially adjacent blades according to the invention;

FIG. 5 is a top view partly showing two circumferentially contiguous platforms according to a first alternative of the invention;

FIG. 6 is a top view partly showing two circumferentially contiguous platforms according to a second alternative of the invention;

FIG. 7 is a top view partly showing two circumferentially contiguous platforms according to a third alternative of the invention;

FIG. 8 is a side view of a first example schematically showing the prestressing of a blade by offsetting towards upstream;

FIG. 9 is a side view of a second example schematically showing the prestressing of a blade resulting from a modification of its curvature;

FIG. 10 is a partial view of a turbomachine rotor element equipped with blades according to the invention.

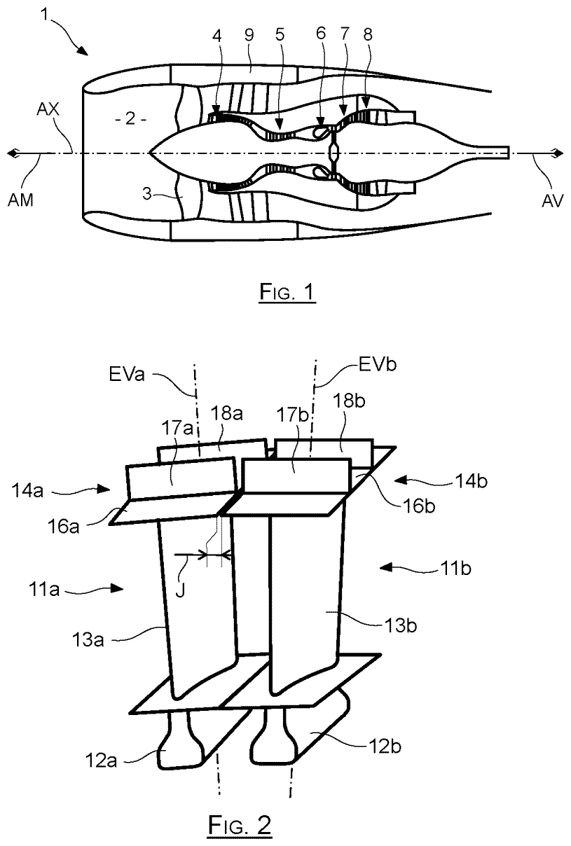

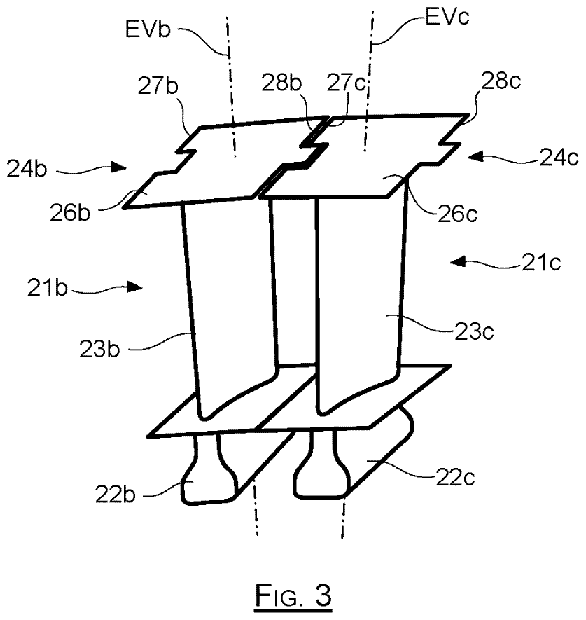

### DETAILED DISCLOSURE OF SPECIFIC EMBODIMENTS

The idea on which the invention is based is to ensure vibration damping by providing platforms having longitudinal edges provided with protrusions and notches that fit together, and that the blades are prestressed alternatingly towards upstream and towards downstream, to axially press this fitting together.

In FIG. 3, a blade 21b includes a root 22b by which it is fastened to a disc (not shown), extended by an aerofoil 23b extending according to a spanwise direction EVb radial with respect to the axis of rotation of the disc. This aerofoil 23b ends in a heel 24b including a platform 26b defined by two edges of circumferential ends 27b and 28b according to the circumferential direction, these edges of circumferential ends being the longitudinal edges of the platform.

Another blade 21c, neighbour of the blade 21b in FIG. 3 and which has the same morphology, includes the same elements designated by the same numerical references but ending with the letter c instead of the letter b. These two blades are carried by the same not-shown disc which rotates about an axis of rotation when the engine is in service.

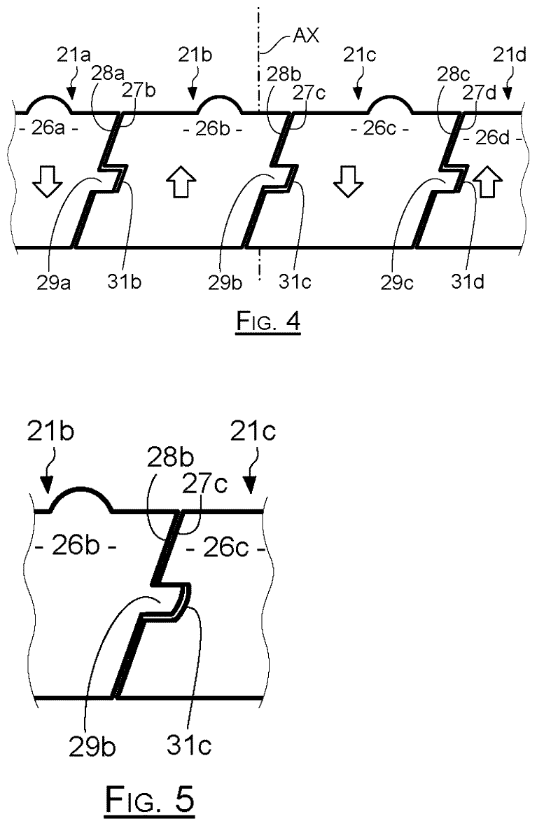

As visible more clearly in FIG. 4, the opposite circumferential end edge 28b of the platform 26b includes a protrusion 29b or protuberance that circumferentially extends the platform 26b according to the circumferential direction to a level located at half of its length according to the axis of rotation AX of this blade. This protrusion has the shape of a lug that extends beyond the edge 28b, while being defined by a contour having the shape of the letter U. This contour shape is given as an example, with it being understood that functionally, a shape defining two contact surfaces is sufficient.

In addition, the edge 27c of the platform 26c, which is facing the edge 28b, includes in its central region a notch 31c or housing, the shape of which is complementary to that of the protrusion 29b. This notch also has the shape of a U, having dimensions slightly greater than that of the protrusion 29b in order to receive it. The platforms 26b and 26c thus fit together according to the circumferential direction by the insertion of the protrusion 29b into the notch 31b. This notch shape is also given as an example, with it being understood that functionally, a shape defining two contact surfaces is sufficient.

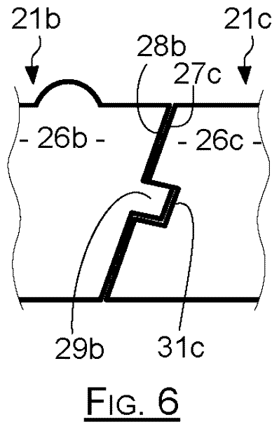

As illustrated in FIG. 5, the protrusions can have rectangular shapes with a rounded edge, and likewise for the corresponding notches. In general, the protrusions and the notches globally have the shape of parallelograms.

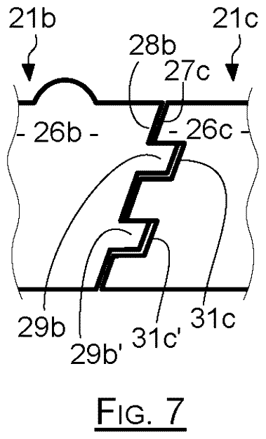

Moreover, and as illustrated in FIG. 6, the protrusions and the notches can extend according to a direction substantially inclined with respect to the circumferential direction instead of extending according to this circumferential direction.

In order to increase the contact surfaces, it is also possible, like in FIG. 7, for the edges of circumferential ends of two contiguous platforms to be provided one with protrusions 29b, 29b′, and the other with several corresponding notches 31c, 31c′.

More generally, each platform includes a longitudinal edge, that is to say an edge of a circumferential end of this platform, provided with a protrusion and its opposite longitudinal edge which is provided with a notch having the same shape, so that all the platforms fit together with each other according to the circumferential direction.

Thus, and as visible in FIG. 4, a platform 26a of a blade 21a adjacent to the blade 21b includes a circumferential end edge 28a that is provided with a protrusion 29a inserted circumferentially into a corresponding notch 31b formed in the circumferential end edge 27b of the platform 26b, which is contiguous to the edge 28a. The opposite circumferential end edge 28b of the platform 26b has its protrusion 29b inserted into the notch 31c of the edge 27c of the platform 26c contiguous to the platform 26b. And likewise, the opposite circumferential end edge 28c of the platform 26c includes a protrusion 29c that is inserted into a corresponding notch 31d formed in a contiguous circumferential end edge 27d of another platform 26d carried by a blade 21d circumferentially adjacent to the blade 21c.

In addition to the adjacent platforms fitting together with each other via their respective protrusions and notches, these circumferentially adjacent blades are prestressed in opposite directions according to the axial direction, as indicated by the arrows in FIG. 4. These prestresses allow to maintain the protrusions and the notches into which they fit bearing against each other according to the axial direction AX.

More particularly, the blades 21b and 21d are prestressed to continually tend to shift their platforms towards downstream, whereas the blades 21a and 21c are prestressed to continually tend to shift their platforms towards upstream.

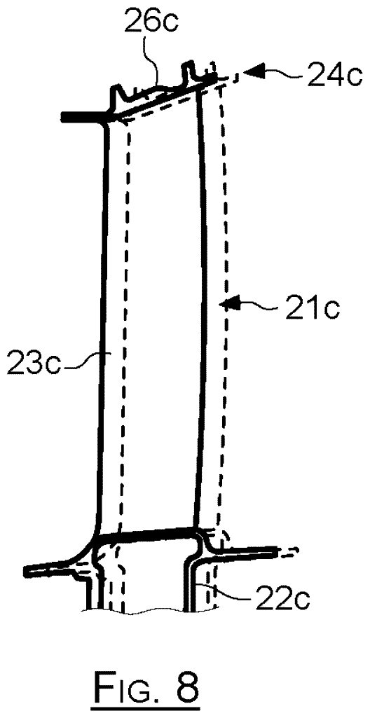

The prestressing of a blade towards upstream can be ensured by offsetting its root towards upstream along the axis AX with respect to the other blades, as schematically illustrated in FIG. 8. In an analogous manner, the prestressing of a blade towards downstream can be obtained by offsetting its root towards downstream with respect to the other blades. Offsetting along the axis AX means here an offsetting of the blade along its axis of insertion into the disc, wherein this axis of insertion usually called setting axis can be slightly inclined with respect to the axis AX.

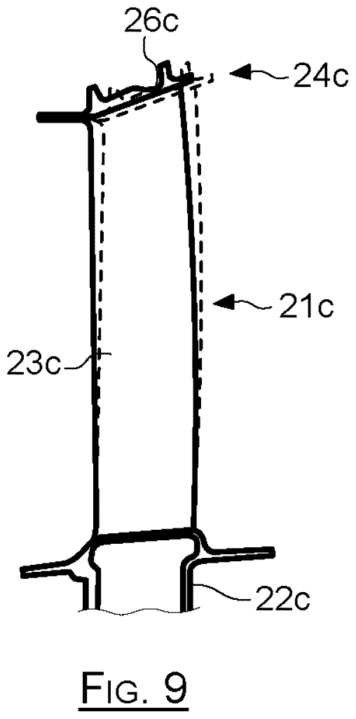

It is also possible to provide on the one hand blades curves towards upstream so that they are prestressed towards upstream, as illustrated in the example of FIG. 9, and on the other hand blades slightly prestressed towards downstream so that they are prestressed towards downstream.

Thus, various relatively simple solutions exist to obtain different prestresses or compensations according to the axial direction on the blades, the latter being arranged in an alternating manner around the disc to be alternatingly prestressed towards upstream and towards downstream.

The alternation of prestress can be obtained by providing an alternation of blades without compensation and blades having a compensation towards upstream or blades having a compensation towards downstream. When the assembly is mounted, the bearing exerted by the non-compensated blades on the compensated blades thus necessarily engenders an alternation of prestress towards upstream and towards downstream.

In these conditions, the protrusions fitting into the corresponding notches axially in contact and bearing on each other allow to damp the modes of vibration. More particularly, when the platforms of two circumferentially adjacent blades move closer together and farther away from each other circumferentially under the effect of a mode of vibration, the axial bearing of the protrusion of one in the notch of the other engenders friction stresses that oppose these movements, to damp the mode of vibration, or even cancel it out, by dissipation of energy.

This damping also functions in the case of a mode of vibration engendering differential movements of the platforms according to their radial directions (spanwise directions).

Moreover, in the case of a mode of vibration having axial movements, the system limits the vibrations since the amplitude of vibration between two adjacent blades is limited by the functional play between the protrusion and the notch by which they are connected. As should be understood, the degree of prestress of the blades towards upstream or towards downstream is dimensioned to generate a pressing stress at the contacts between ends of fins allowing to dissipate the energy resulting from the modes of vibration.

In the example of FIGS. 3 and 4, each blade includes an edge of circumferential end provided with a protrusion and an opposite edge of circumferential end provided with a notch, so that the blades have platforms that are all identical. Another possibility could involve providing an alternation including on the one hand blades, the edges of circumferential ends of which each have a notch and on the other hand blades, the edges of circumferential ends of which each have a protrusion. It is also possible to provide several protrusions and notches on the same edge so as to increase the contact surface. A bladed assembly including blades according to the invention can belong to a turbomachine rotor element, such as the rotor disc DR, a part of which is shown in FIG. 10. The blades 21a, 21b can thus be mounted by their roots in corresponding cells of this disc DR while forming a ring of blades 21a, 21b that surround the disc DR while being carried by the latter.

In general, the invention was shown for rotary blades including a platform and at least one fin portion manufactured from a material of the CMC type, but the invention also applies to blades made of metal alloy.

1. Bladed turbomachine assembly extending circumferentially about an axis of rotation and comprising blades wherein each blade extends radially with respect to the axis of rotation up to a heel located at a free end of the blade and including a platform, characterised in that:
it includes, circumferentially arranged about the axis of rotation, an alternation of blades prestressed towards upstream and blades prestressed towards downstream, each blade prestressed towards upstream having its heel tending to shift towards upstream, each blade prestressed towards downstream having its heel tending to shift towards downstream;
the pairs of circumferentially adjacent blades have platforms, the circumferentially contiguous edges of the circumferential ends of which include protrusions and notches fitting together in one another;
each protrusion is in axial contact in a notch receiving it, this contact being maintained by the prestresses of the blades that carry them.

2. Bladed assembly according to claim 1, wherein the protrusions and the notches globally each have the shape of a parallelogram.

3. Bladed assembly according to claim 2, wherein the protrusions and the notches extend according to a direction mainly circumferential with respect to the axis of rotation.

4. Bladed assembly according to claim 1, wherein each edge of a circumferential end of a platform includes several protrusions or several notches.

5. Bladed assembly according to claim 1, wherein each platform includes one circumferential end edge provided with at least one notch, and another circumferentially opposite circumferential end edge that is provided with at least one protrusion

6. Bladed assembly according to claim 1, wherein the blades are made of ceramic matrix composite material.

7. Bladed assembly according to claim 1, wherein the blades are prestressed by offsetting according to the axis of rotation their roots with respect to the disc that carries them.

8. Bladed assembly according to one of claim 1, wherein the blades are prestressed by being curved towards upstream or towards downstream when viewed in a plane containing the axis of rotation.

9. Turbomachine comprising a bladed assembly according to claim 1.
